(19) United States
(12) Patent Application Publication
(10) Pub. No.: US 2017/0049085 A1
(43) Pub. Date: Feb. 23, 2017

(54) Lighted Fish Landing Net

(71) Applicant: Academy, Ltd., Katy, TX (US)

(72) Inventors: Christopher M. Williford, Katy, TX (US); Dennis Krieger, Katy, TX (US)

(21) Appl. No.: 14/832,263

(22) Filed: Aug. 21, 2015

(51) Int. Cl. A01K 75/02; A01K 77/00

(52) U.S. Cl. CPC A01K 75/02; A01K 77/00

(57) ABSTRACT

Disclosed is a lighted fish landing net that includes a net including an upper perimeter, a net support that supports the net at the upper perimeter and includes an elongated support body and a channel extending along the elongated body, an optical fiber extending at least partially through the channel with a first end and an elongated surface extending at least partially along the channel, and at least one light source positioned proximate the first end. The light source may emit light that is incident on the first end of the optical fiber such that light is emitted from the elongated surface of the optical fiber along the channel.

### FIELD

Fish landing nets.

### BACKGROUND

Anglers use landing nets to remove hooked fish from the water and reduce the chance of the fish throwing the hook. The use of a net also minimizes injury to the fish by reducing forces applied through the hook thereby increasing the effectiveness of catch-and-release. Furthermore, landing nets reduce potential injuries to the angler due to sudden movement of a fish in the water. Optimum fishing often occurs in low light situations including dawn, dusk, or night conditions.

### SUMMARY

This patent is for a lighted fish landing net. The lighted fish landing net may utilize an optical fiber or other illumination device.

As one non-limiting example, the lighted fish landing net may include: a net including an upper perimeter, a net support that supports the net at the upper perimeter and includes an elongated support body and a channel extending along the elongated body, an optical fiber extending at least partially through the channel with a first end and an elongated surface extending at least partially along the channel, and at least one light source positioned proximate the first end. The light source may emit light that is incident on the first end of the optical fiber such that light is emitted from the elongated surface of the optical fiber along the channel.

In another non-limiting example, the lighted fish landing net may include: an elongated shaft with a first end and a second end opposite of the first end where the elongated shaft includes a grip portion adjacent to the first end, a net support fitting attached to the second end of the elongated shaft, a net support including two ends where each end is attached to the net support fitting, and an illumination member disposed within a channel extending along a length of the net support.

### BRIEF DESCRIPTION OF THE DRAWINGS

FIGS. 1 through 15 show non-limiting examples of lighted fish landing nets.

FIG. 1 is a front view of one example of fish landing net.

FIGS. 2A and 2B are perspective views of the fish landing net of FIG. 1.

FIG. 3A is a front view of a net support fitting of the fish landing net of FIG. 1.

FIG. 3B is a rear view of the net support fitting of the fish landing net of FIG. 1.

FIG. 4 is a detail perspective view of a net support of the fish landing net of FIG. 1.

FIG. 5 is rear view of the fish landing net of FIG. 1.

FIG. 6 is cross-sectional view of a net support of the fish landing net of FIG. 1.

FIGS. 7A, 7B, and 7C are detail rear views of the fish landing net of FIG. 1.

FIG. 8 is a detail perspective view of a net support fitting of the fish landing net of FIG. 1.

FIGS. 9A and 9B are detail views of a grip of the fish landing net of FIG. 1.

FIG. 10 is another front view of the fish landing net of FIG. 1.

FIG. 11 is a rear view of the fish landing net of FIG. 10.

FIG. 12 is a perspective view of the fish landing net of FIG. 10.

FIG. 13 is a left side view of the fish landing net of FIG. 10.

FIG. 14 is a right side view of the fish landing net of FIG. 10.

FIG. 15 is a top view of the fish landing net of FIG. 10.

FIG. 16 is a bottom view of the fish landing net of FIG. 10.

FIG. 17 is a detail view of a net support of the fish landing net of FIG. 10.

FIG. 18 is a detail view of a net support fitting of the fish landing net of FIG. 12.

### DETAILED DESCRIPTION

This section describes non-limiting examples of fish landing nets and does not limit the scope of the claimed subject matter. The claimed subject matter may be embodied in other ways, may include different elements or other attributes, and may be used in conjunction with other existing or future technologies. This description should not be interpreted as requiring any particular order or arrangement among or between various elements.

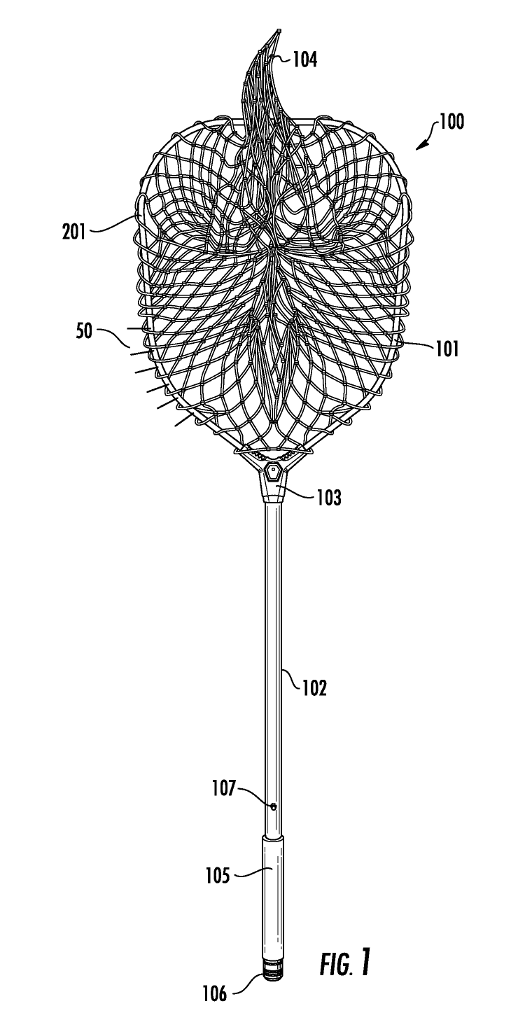

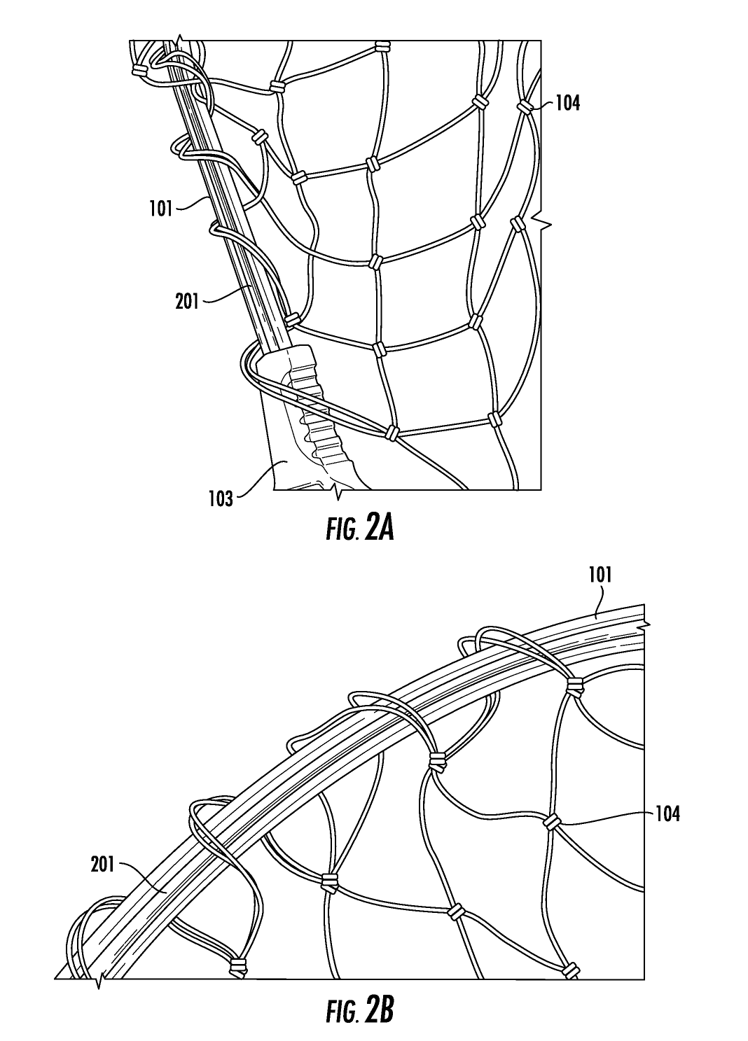

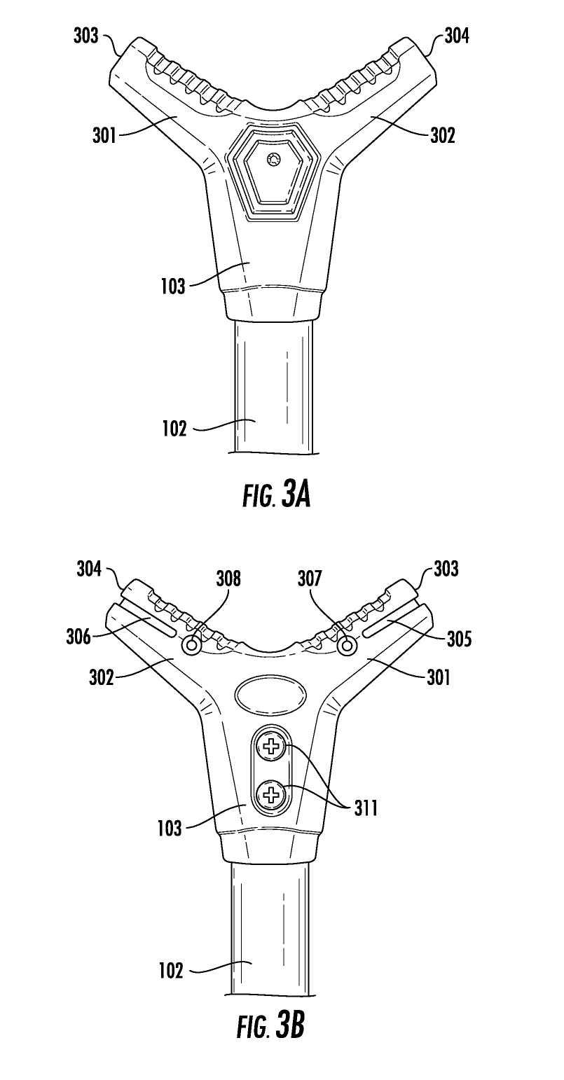

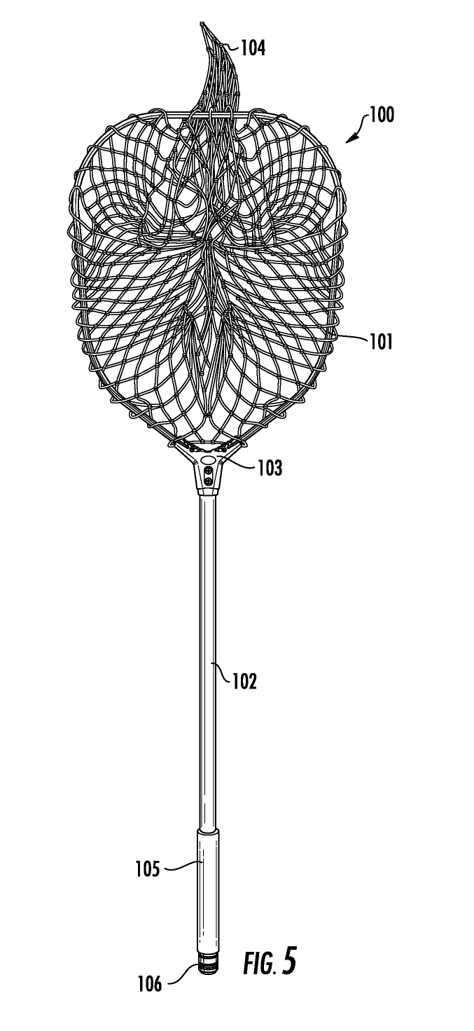

FIGS. 1-9B illustrate an example of a lighted fish landing net 100. In this example, the fish landing net 100 includes a net support 101, an elongated shaft 102, and a net support fitting 103 configured to attach the net support 101 to the shaft 102. The net support 101 may include an elongated support body that supports a net 104 at the net's upper perimeter and that defines an opening to the “interior” of the net (see FIG. 1). The shaft 102 includes a grip 105 and one or more switches 106, 107. The fish landing net 100 also includes an illumination member 201 located on the forward face 401 of the net support 101 where the illumination member 201 produces light 50. FIG. 4 shows illumination member 201 in more detail.

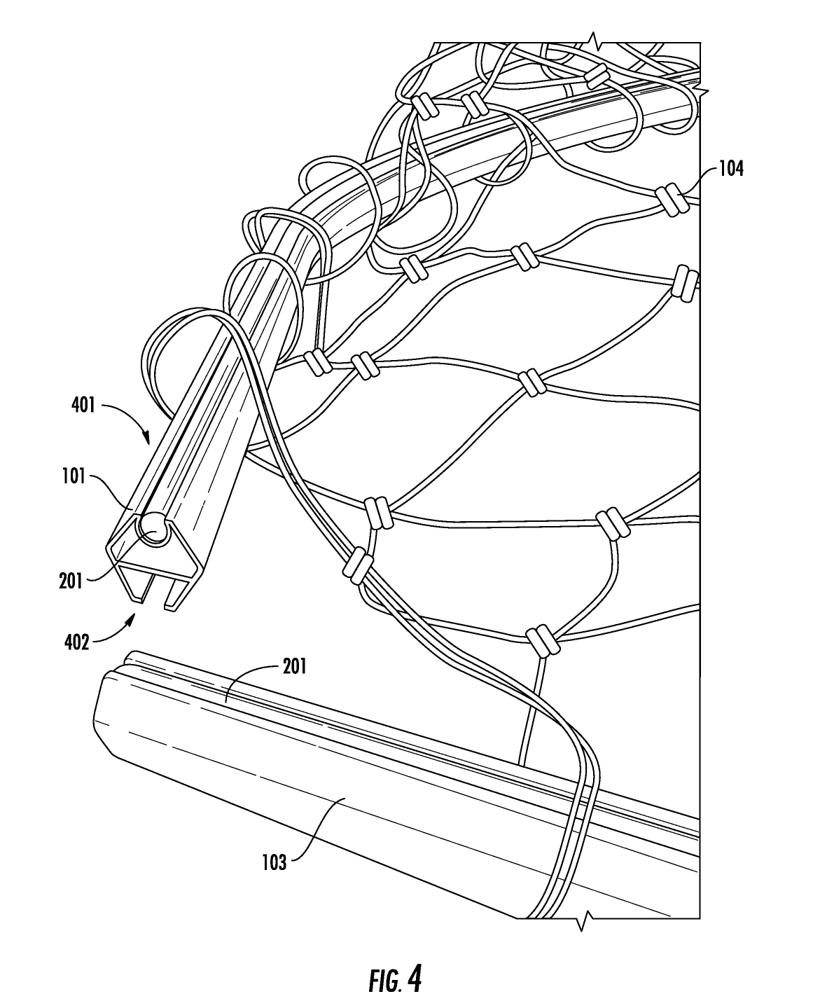

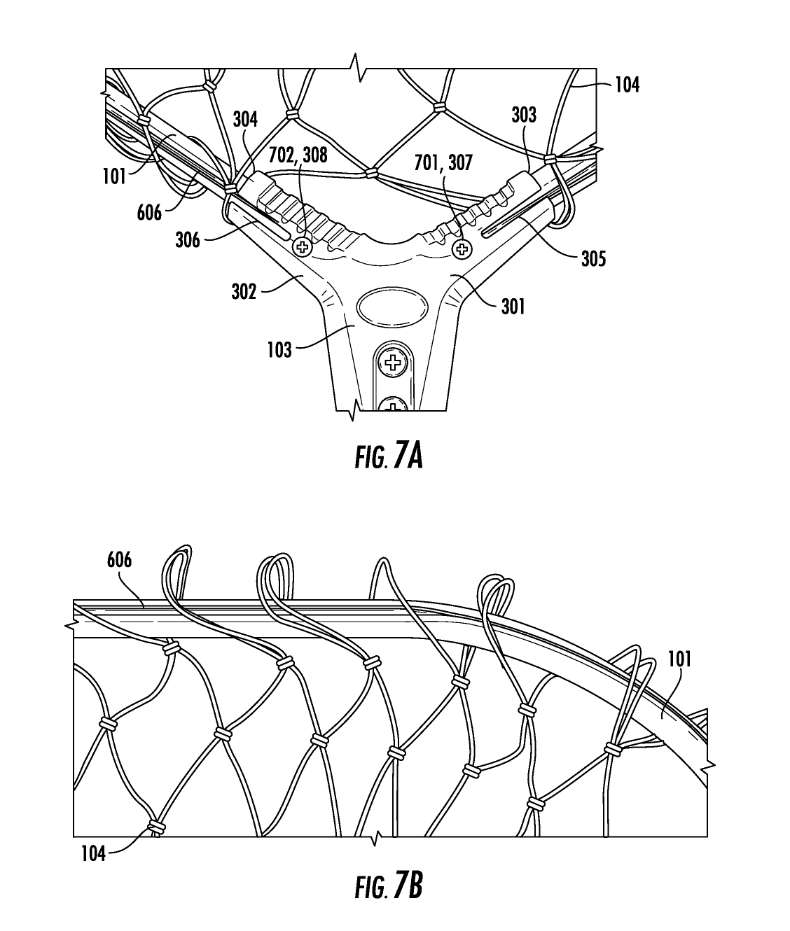

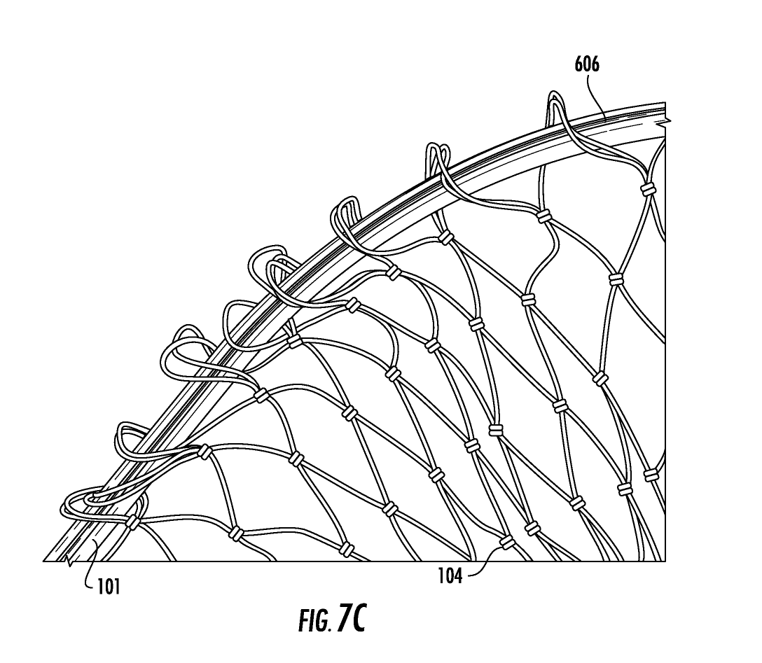

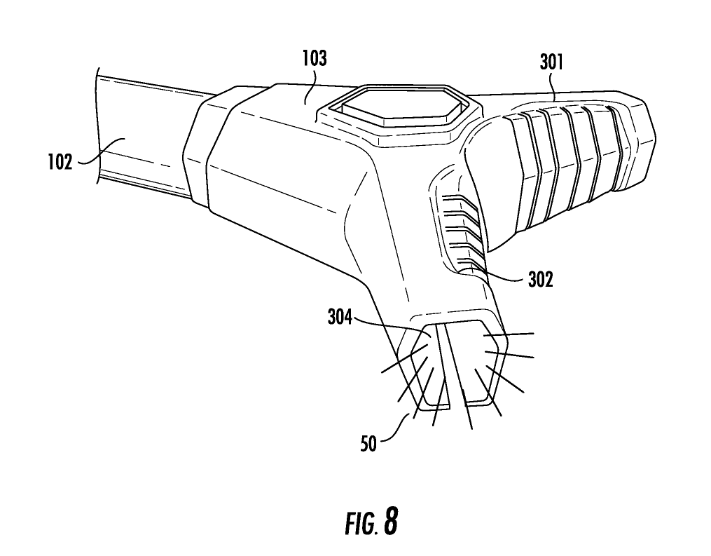

As shown in FIG. 1, the first end of the elongated shaft 102 includes a grip portion 105 and the second end of the elongated shaft attaches to the net support fitting 103. As shown in FIGS. 3A and 3B, the net support fitting 103 includes a first arm 301 and a second arm 302 such that each arm has an opening (first opening 303 and second opening 304, respectively). The net support 101 has two ends (see FIG. 4) where the two ends are inserted into openings 303 and 304 of net support fitting 103 (see FIG. 7A). As shown in FIGS. 3B and 7A, the fish landing net 100 includes fasteners 701 and 702, which are inserted into holes 307 and 308, respectively, to secure the net support 101 in the net support fitting 103. In addition, one or more fasteners 311 attach the net support fitting 103 to the elongated shaft 102. As shown in FIG. 3B, the rear side of the net support fitting 103 includes slots 305 and 306, which allow portions of the net support 101 to be visible when inserted into arms 301 and 302 through holes 307 and 308. The net support fitting 103 shown in the figures is just one example of how a net support may be attached to the shaft of the landing net.

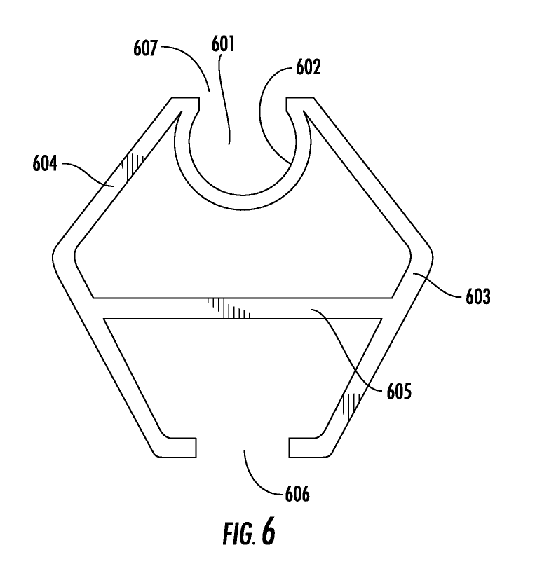

FIG. 4 shows a detailed view of the illumination member 201 inserted within a channel 601 of the net support 101 (see also FIG. 6). In some embodiments, the illumination member 201 and the channel 601 have similar cross-sections to ensure that the illumination member 201 fits securely within the channel 601. FIG. 4 shows examples of the illumination member 201 and the channel 601 that have circular cross-sections. However, any other appropriate cross-sectional shape may be utilized, such as rectangular, square, pentagonal, or any other shape.

As shown in FIG. 6, the cross-section of the net support 101 includes a channel 601 that includes an inner surface 602 and an opening 607 such that a portion of the illumination member 201 is exposed through opening 607. The channel 601 is between a first side 603 and a second side 604 of the net support 101, which form the inner and/or outer surfaces of the net support 101. The net support 101 also includes stiffening member 605, which spans between the first side 603 and the second side 604. As shown in FIG. 6, the first and second sides 603, 604 each include a corner between the forward face 401 of the net support 101 and the rear face 402 of the net support 101. On the rear face 402 of the net support 101 (opposite of the channel 601 and the illumination member 201) is an opening 606. As shown in FIG. 7B, the opening 606 has a variable width to facilitate bends in the net support 101. In particular, as shown in FIG. 7B, to allow the net support 101 to match a curved contour (i.e., where the inner and outer portions of the net support 101 have different radii), the opening 606 contracts in the curved area.

In some embodiments, the illumination member 201 is fully contained within the net support 101 such that light can be emitted through opening 607. In some embodiments, a portion of the illumination member 201 protrudes through the opening 607 of the net support 101.

The illumination member 201 may be an optical fiber (i.e., part of a fiber optic light system), a light emitting diode (LED) strip, or any other suitable light. The illumination member 201 may be a flexible side-emitting optical fiber (cylindrical shape) configured to emit light through the curved surface of the optical fiber (the optical fiber may also emit light through one or both ends). In some embodiments, the side-emitting optical fiber includes multiple fibers wrapped around a reflective polyvinyl chloride core. The illumination member 201 may be an optical fiber that is a monofilament or may have multiple optic strands. In some embodiments, to reduce the exposure of wired lights to moisture (i.e., the net support is intended to be submerged), the illumination member 201 may be an optical fiber such that no electricity propagates through the net support 101. In other words, light is transferred through the illumination member 201 without electricity travelling through the illumination member 201.

As shown in FIG. 8, a light source may be disposed within the net support fitting 103 such that light is sent through one or both of the openings 303 and 304 (FIG. 8 shows the net support fitting 103 without the net support 101) such that the light is incident on the end of the illumination member 201. The light source within the net support fitting 103 may be precisely aimed to align with one or both ends of the illumination member 201 (e.g., see FIG. 4). In some embodiments, the light source is positioned such that it is offset and does not emit light through the center of openings 303 and 304. In some embodiments, the light source located inside the net support fitting 103 is an LED light, a fluorescent light, an incandescent light, a halogen light, a neon light, or any other suitable type of light. The light source may be configured to emit multiple colors of light. The net support fitting 103 (1) may include one or more light sources for one or both ends of the illumination member 201, (2) may include a single light source with optics configured to direct light to both ends of the illumination member 201, (3) may include a single light source configured to emit light toward one end of the illumination member 201, or (4) may be configured in other manners.

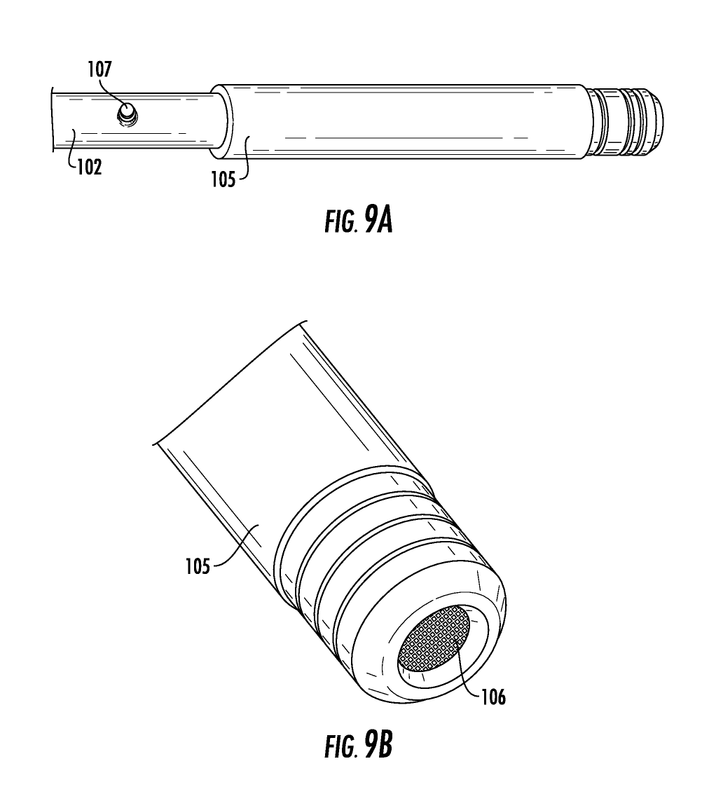

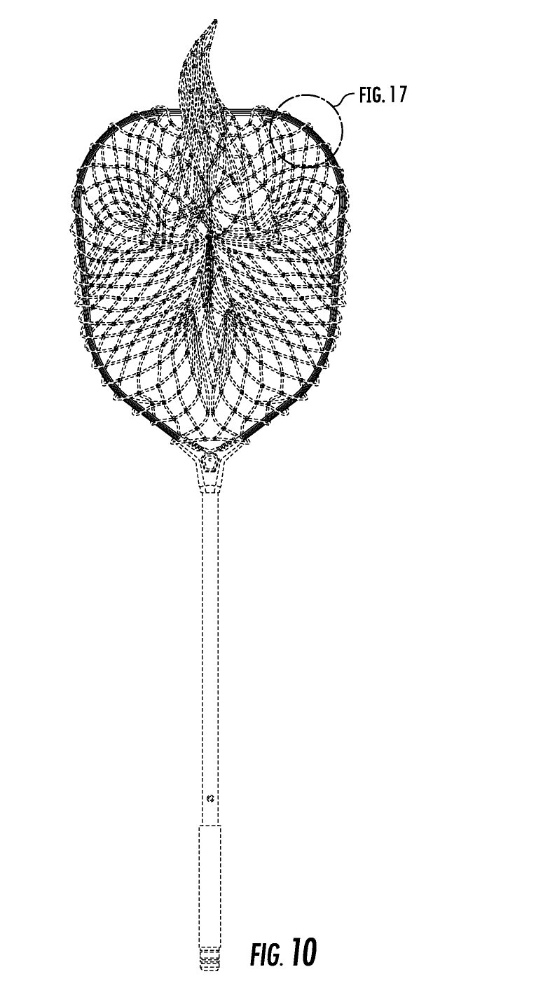

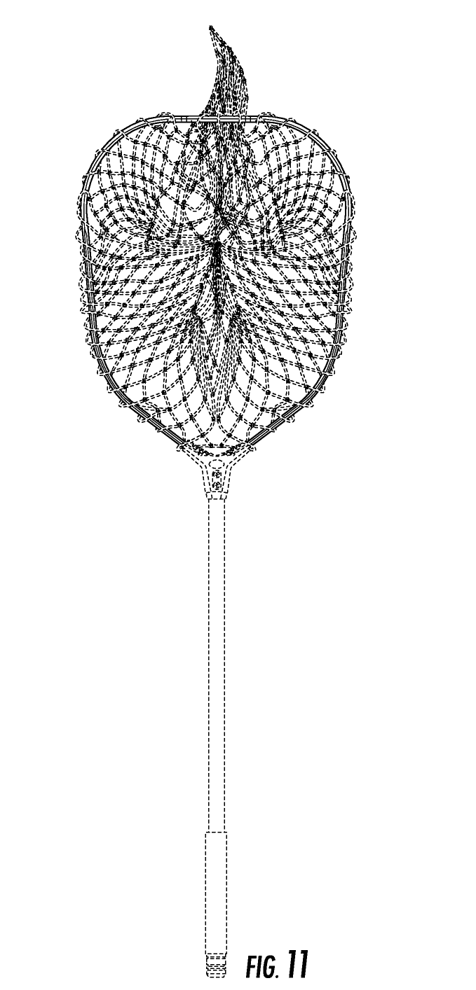

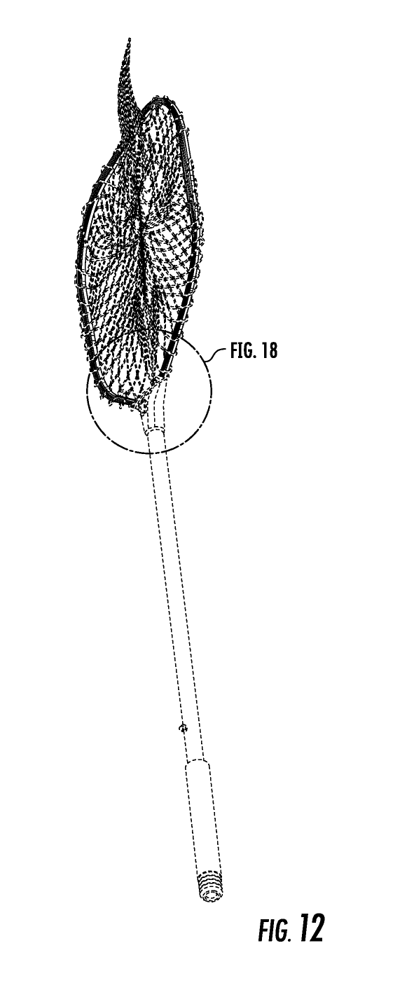

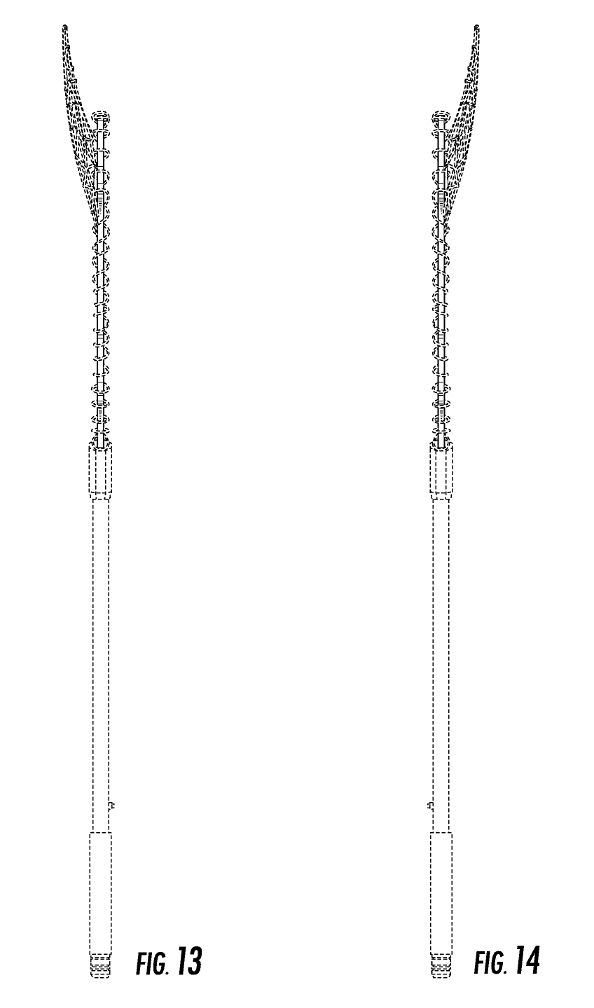

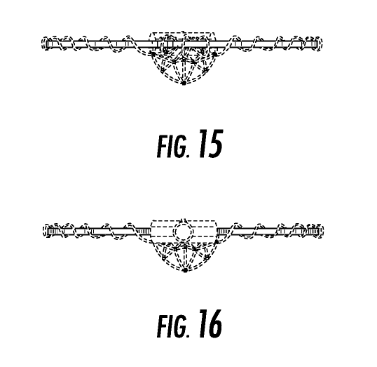

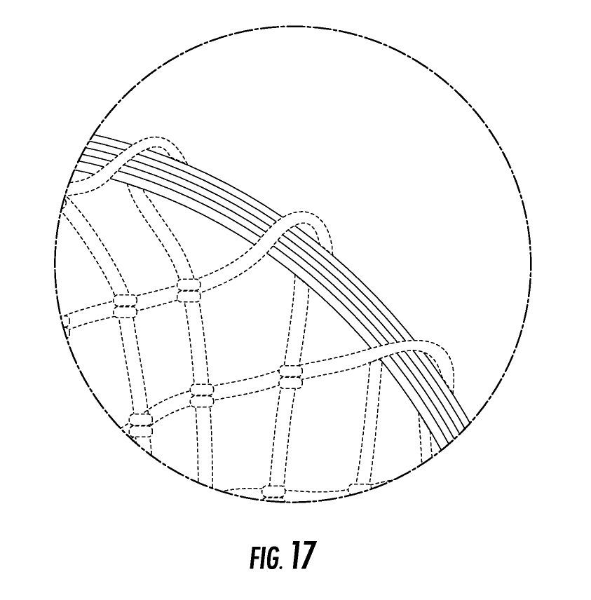

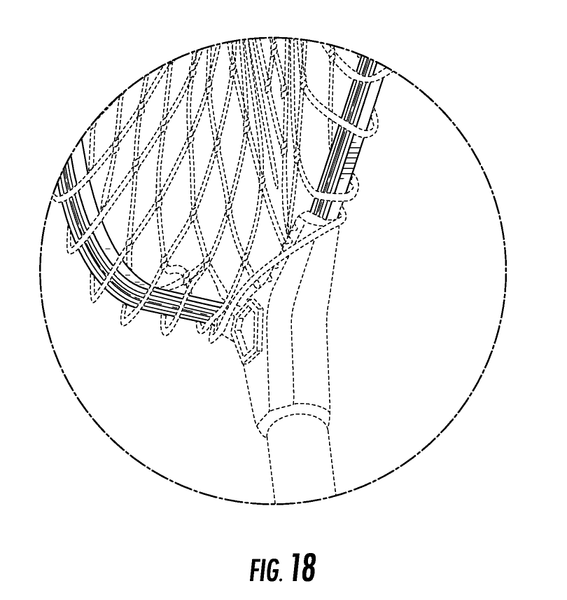

Actuation of the illumination member 201 may be controlled using one or more switches. For example, FIGS. 1, 9A, and 9B show switches 106 and 107. In some embodiments, one of the switches is a two-position master switch that turns power on or off to the illumination member. The fish landing net 100 may include an additional three-position switch for controlling the signal to the illumination member that may allow for an fixed and continuous “on” condition (fixed), a regular continuous periodic “flashing” condition, and an “off” condition.

The overall shape of the perimeter of the net support 101 may be a teardrop, a scooper or a D-hoop configuration. The net 104 may be a knotted mesh (made from polyethylene, nylon, or any other suitable material) and may include a coating that seals the individual strands to prevent hooks from penetrating. In some embodiments, the net 104 is a knotless mesh net such as a nylon micro mesh net, a tangle-free rubber net, or any other suitable knotless net.

The components of the fish landing net 100 may be formed of materials including, but not limited to, aluminum, extruded aluminum, machined aluminum, carbon composite, plastic, thermoplastic, other aluminum materials, steel, stainless steel, other plastic or polymer materials, rubber, other metallic materials, other composite materials, or other similar materials. Moreover, the components of the fish landing net 100 may be attached to one another via suitable fasteners, which include, but are not limited to, screws, bolts, rivets, any suitable type of weld, or other mechanical or chemical fasteners.

Different arrangements of the components depicted in the drawings or described above, as well as components and steps not shown or described are possible. Similarly, some features and sub-combinations are useful and may be employed without reference to other features and sub-combinations. Embodiments of the apparatus have been described for illustrative and not restrictive purposes, and alternative embodiments will become apparent to readers of this patent. Accordingly, the present apparatus is not limited to the embodiments described above or depicted in the drawings, and various embodiments and modifications may be made without departing from the scope of the claims below.

That which is claimed is:

1. A lighted fish landing net, comprising:
a. a net, the net comprising an upper perimeter;
b. a net support, the net support supporting the net at the upper perimeter, the net support comprising an elongated support body and a channel extending along the elongated support body;
c. an optical fiber extending at least partially through the channel, the optical fiber including at least a first end and an elongated surface extending at least partially along the channel; and
d. at least one light source positioned proximate the first end, the at least one light source configured to emit light that is incident on the first end of the optical fiber such that light is emitted from the elongated surface of the optical fiber along the channel.

2. The lighted fish landing net of claim 1, wherein the optical fiber further comprises a second end, wherein the lighted fish landing net further comprises a second light source positioned proximate the second end of the optical fiber, the second light source configured to emit light that is incident on the second end of the optical fiber such that light is emitted from the elongated surface of the optical fiber along the channel.

3. The lighted fish landing net of claim 1, wherein the channel of the net support comprises an opening extending at least partially along the channel, wherein the opening exposes at least a portion of the elongated surface of the optical fiber.

4. The lighted fish landing net of claim 3, wherein the net support comprises a forward face and a rear face opposite the forward face, wherein the opening extends at least partially along the forward face, and does not extend along the rear face.

5. The lighted fish landing net of claim 3, wherein at least a portion of the optical fiber protrudes through the opening of the channel of the net support.

6. The lighted fish landing net of claim 1, further comprising a net support fitting, wherein the net support comprises a first end and a second end, wherein the first and second ends of the net support are connected to the net support fitting, wherein the at least one light source is positioned inside the net support fitting.

7. The lighted fish landing net of claim 6, further comprising an elongated shaft extending from the net support fitting, the elongated shaft comprising a first switch configured to selectively activate and de-activate the at least one light source.

8. The lighted fish landing net of claim 7, further comprising a second switch configured to selectively activate the at least one light source for a fixed and continuous “on” condition, a regular continuous periodic “flashing” condition, and an “off” condition.

9. The lighted fish landing net of claim 1, wherein the at least one light source is selected from the group consisting of an LED light, a fluorescent light, an incandescent light, a halogen light, and a neon light.

10. The lighted fish landing net of claim 1, wherein the net support comprises a first side, a second side, and a stiffening member spanning between the first side and the second side.

11. The lighted fish landing net of claim 10, wherein the first and second sides each include a corner between a forward face of the net support and a rear face of the net support.

12. The lighted fish landing net of claim 1, wherein the at least one light source is configured to emit multiple colors of light.

13. A lighted fish landing net, comprising:
an elongated shaft with a first end and a second end opposite of the first end, the elongated shaft comprising a grip portion adjacent to the first end;
a net support fitting attached to the second end of the elongated shaft;
a net support comprising two ends where each end is attached to the net support fitting; and
an illumination member disposed within a channel extending along a length of the net support.

14. The lighted fish landing net of claim 13, wherein an internal shape of the channel matches a shape of the illumination member.

15. The lighted fish landing net of claim 14, wherein the internal shape of the channel comprises a cross-section that is a circular segment.

16. The lighted fish landing net of claim 13, wherein the channel comprises an opening configured to direct light through the opening.

17. The lighted fish landing net of claim 13, wherein the illumination member comprises an optical fiber with a first end.

18. The lighted fish landing net of claim 17, further comprising at least one light source positioned proximate the first end, the at least one light source configured to emit light that is incident on the first end of the optical fiber such that light is emitted from a side surface of the optical fiber along the channel.

19. The lighted fish landing net of claim 13, further comprising a first switch configured to selectively activate and de-activate the illumination member.

20. The lighted fish landing net of claim 19, further comprising a second switch configured to selectively activate the illumination member for a fixed and continuous “on” condition, a regular continuous periodic “flashing” condition, and an “off” condition.
